(19) United States
(12) Patent Application Publication
(10) Pub. No.: US 2004/0015495 A1
(43) Pub. Date: Jan. 22, 2004

(54) Apparatus and method for retrieving face images using combined component descriptors

(75) Inventors: Taekyun Kim, Kyungki-do (KR); Sangryong Kim, Kyungki-do (KR); Seokcheol Kee, Kyungki-do (KR); Wonjun Hwang, Seoul (KR); Hyunwoo Kim, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/618,857

(22) Filed: Jul. 15, 2003

(30) Foreign Application Priority Data
Jul. 15, 2002 (KR) 10-2002-0041406
Dec. 31, 2002 (KR) 10-2002-0087920

(51) Int. Cl. G06F 7/00

(52) U.S. Cl. 707/3

(57) ABSTRACT

Disclosed herein is an apparatus and method for retrieving face images using combined component descriptors. The apparatus of the present invention includes an image division unit for dividing an input image into facial components, a first Linear Discriminant Analysis transformation unit for LDA transforming the divided facial components into component descriptors of the facial components, a vector synthesis unit for synthesizing the transformed component descriptors into a single vector, a second Generalized Discriminant Analysis transformation unit for GDA transforming the single vector into a single face descriptor, and a similarity determination unit. The similarity determination unit determines similarities between an input query face image and face images stored in a face image database by comparing a face descriptor of the input query face image with face descriptors of the face images stored in the face image database.

The present invention claims priority from Korean Patent Application Nos. 10-2002-0041406 filed Jul. 15, 2002 and 10-2002-0087920 filed Dec. 31, 2002, which are incorporated herein full by reference.

### BACKGROUND

1. Field of the Invention

The present invention relates generally to an apparatus and method for retrieving face images, using combined component descriptors.

2. Description of the Related Art

Generally, in face image retrieval technologies, a face image input by a user (hereinafter referred to as “queried face image”) is compared with face images stored in a face image database (DB) (hereinafter referred to as “trained face images”) to thereby retrieve from the DB a trained face image identical with or the most similar to the queried face image as inputted.

In order to obtain a retrieval result as accurate as possible when retrieving a stored face image the most similar to the queried face image, among stored face images, face images of each person must be databased by means of features that can represent the best identify of the person having the face images, irregardless of illumination, posture of or facial expression of the person. Considering that the database would be of a large volume, storing therein a large number of face images relative to a lot of persons, a method of determining the similarity in a simple manner is necessary.

In general, a face image is comprised of pixels. These pixels are presented in one column vector and the dimensionality of the vector is considerably large. For this reason, various researches have been carried out, to represent face images using a small amount of data while maintaining precision and to find out the most similar face image with a small number of calculations when retrieving a stored face image the most similar to the queried face images from a face image DB.

As those methods that can represent face images with a small amount of data and retrieve a face image with a small number of calculations while obtaining accurate retrieval results, there are currently PCA, LDA and the like. The PCA stands for “Principal Components Analysis,” using an eigenface, and the LDA stands for “Linear Discriminant Analysis” wherein the projection W (transformation matrix) to maximize between-class (person) scatters and to minimize within-class scatter (between-various images of a person) is determined, and represent a face image with a predetermined descriptor by use of the determined projection W.

Additionally, there is used a method of retrieving face images in such a way that an entire face image is divided into several facial components, e.g., eyes, a nose and a mouth, rather than being represented as it is, wherein feature vectors are extracted from the facial components and the extracted feature vectors are compared with each other with the weights of the components being taken into account.

A method of retrieving face images by applying the LDA method to divided facial components is described in Korean Patent Appln. 10-2002-0023255 entitled “Component-based Linear Discriminant Analysis (LDA) Facial Descriptor.”

However, since those conventional methods compare all the feature vector data of respective components with one another, the amount of data that are compared with one another is considerably increased when training face images of high capacity are compared with one another, so the processing of data becomes inefficient and the processing time of data is lengthened. Additionally, those conventional methods do not sufficiently consider correlations between the facial components, and the precision of retrieval is insufficient.

### SUMMARY

Accordingly, the present invention has been made keeping in mind the above problems occurring in the prior art, and an object of the present invention is to provide an apparatus and method for retrieving face images using combined component descriptors, which generates lower-dimensional face descriptors by combining component descriptors generated with respect to facial components and compares the lower-dimensional face descriptors with each other, thus enabling precise face image retrieval while reducing the amount of data and retrieval time required for face image retrieval.

Another object of the present invention is to provide an apparatus and method for retrieving face images using combined component descriptors, which utilizes an input query face image and training face images similar to the input query face image as comparison references at the time of face retrieval, thus providing a relatively high face retrieval rate.

In order to accomplish the above object, the present invention provides an apparatus for retrieving face images using combined component descriptors, including an image division unit for dividing an input image into facial components, a LDA transformation unit for LDA transforming the divided facial components into component descriptors of the facial components, a vector synthesis unit for synthesizing the transformed component descriptors into a single vector, a Generalized Discriminant Analysis (GDA) transformation unit for GDA transforming the single vector into a single face descriptor, and a similarity determination unit for determining similarities between an input query face image and face images stored in an face image DB by comparing a face descriptor of the input query face image with face descriptors of the face images stored in the face image DB.

Preferably, the LDA transformation units comprises LDA transformation units for LDA transforming the divided facial components into component descriptors of the facial components, and vector normalization units for vector normalizing the transformed component descriptors into a one-dimensional vector, and the LDA transformation units and vector normalization units are each provided for the divided facial components.

Desirably, the image DB stores face descriptors of the face images, and the comparison of the input query face image with the face images of the image DB is performed by comparing the face descriptor of the input query face image with the face descriptors of the face images stored in the image DB, and the divided face components are partially overlapped with each other, and the face components into which the input face image is divided comprises eyes, a nose and a mouth.

The similarity determination unit extracts first similar face images similar to the input query face image and second similar face images similar to the first face images from the image DB, and determines similarities between the input query face image and the face images of the image DB using the similarities between the input query face image and the second similar face images. At this time, the determination of the similarities between the input query face image and the face images of the image DB is performed using the following equation

$$Joint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$

where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.

More preferably, the apparatus according to the present invention further comprises a transformation matrix/transformation coefficient DB for storing a transformation matrix or transformation coefficients calculated by training the face images stored in the image DB, wherein the LDA transformation unit or the GDA transformation unit performs LDA transformation or GDA transformation using the stored transformation matrix or transformation coefficients.

According to another embodiment of the present invention, an apparatus for retrieving face images using combined component descriptors comprises an image division unit for dividing an input image into facial components, a first Linear Discriminant Analysis (LDA) transformation unit for LDA transforming the divided facial components into component descriptors of the facial components, a vector synthesis unit for synthesizing the transformed component descriptors into a single vector, a second LDA transformation unit for LDA transforming the single vector into a single face descriptor, and a similarity determination unit for determining similarities between an input query face image and face images stored in an face image database (DB) by comparing a face descriptor of the input query face image with face descriptors of the face images stored in the face image DB.

Preferably, the first LDA transformation unit comprises LDA transformation units for LDA transforming the divided facial components into component descriptors of the facial components, and vector normalization units for vector normalizing the transformed component descriptors into a one-dimensional vector, and the LDA transformation units and vector normalization units are each provided for the divided facial components.

Preferably, the image DB stores face descriptors of the face images, and the comparison of the input query face image with the face images of the image DB is performed by comparing the face descriptor of the input query face image with the face descriptors of the face images stored in the image DB, the divided face components are partially overlapped with each other, and the face components into which the input face image is divided comprises eyes, a nose and a mouth.

The similarity determination unit extracts first similar face images similar to the input query face image and second similar face images similar to the first face images from the image DB, and determines similarities between the input query face image and the face images of the image DB using the similarities between the input query face image and the second similar face images. At this time, the determination of the similarities between the input query face image and the face images of the image DB is performed using the following equation

$$Joint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$

where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.

More preferably, the apparatus according to the present invention further comprises a transformation matrix/transformation coefficient DB for storing a transformation matrix or transformation coefficients calculated by training the face images stored in the image DB, wherein the first LDA transformation unit or the second LDA transformation unit performs LDA transformation using the stored transformation matrix or transformation coefficients.

In order to accomplish the above object, the present invention provides a method of retrieving face images using combined component descriptors, including the steps of dividing an input image into facial components, LDA transforming the divided facial components into component descriptors of the facial components, synthesizing the transformed component descriptors into a single vector, GDA transforming the single vector into a single face descriptor, and determining similarities between an input query face image and face images stored in an face image DB by comparing a face descriptor of the input query face image with face descriptors of the face images stored in the face image DB. The step of LDA transforming the divided facial components comprises the steps of LDA transforming the divided facial components into component descriptors of the facial components, and vector normalizing the transformed component descriptors into a one-dimensional vector, wherein the LDA transforming or the GDA transforming is carried out using a transformation matrix or a transformation coefficient calculated by training the face images stored in the image DB.

The comparing of the input query face image with the face images of the image DB is performed by comparing the face descriptor of the input query face image with the face descriptors of the face images stored in the image DB, and the divided face components are partially overlapped with each other. The face components into which the input face image is divided comprises eyes, a nose and a mouth.

The step of determining similarities comprises the steps of extracting first similar face images similar to the input query face image and second similar face images similar to the first face images from the image DB, and determining similarities between the input query face image and the face images of the image DB using the similarities between the input query face image and the second similar face images. At this time, the step of extracting the first and second similar face images comprises the first similarity determination step of determining similarities between the input query face image and the face images of the image DB, the first similar face image extraction step of extracting the first similar face images in an order of similarities according to results of the first similarity determination step, the second similarity determination step of determining similarities between the first similar face images and the face images of the image DB, and the second similar face image extraction step of extracting the second similar face images for each of the first similar face images in an order of similarities according to results of the second similarity determination step. The determining of similarities between the input query face image and the face images of the image DB is performed using the following equation

$$Joint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$

where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.

Desirably, the method according to the present invention further comprises the step of outputting the face images of the image DB retrieved based on the determined similarities

In addition, the present invention provides a method of retrieving face images using combined component descriptors, including the steps of dividing an input image into facial components, LDA transforming the divided facial components into component descriptors of the facial components, synthesizing the transformed component descriptors into a single vector, LDA transforming the single vector into a single face descriptor, and determining similarities between an input query face image and face images stored in an face image DB by comparing a face descriptor of the input query face image with face descriptors of the face images stored in the face image DB.

Preferably, the step of LDA transforming the divided facial components comprises the steps of LDA transforming the divided facial components into component descriptors of the facial components, and vector normalizing the transformed component descriptors into a one-dimensional vector, and the LDA transforming is carried out using a transformation matrix or a transformation coefficient calculated by training the face images stored in the image DB.

The comparing of the input query face image with the face images of the image DB is performed by comparing the face descriptor of the input query face image with the face descriptors of the face images stored in the image DB. The divided face components are partially overlapped with each other. The face components into which the input face image is divided comprises eyes, a nose and a mouth.

The step of determining similarities comprises the steps of extracting first similar face images similar to the input query face image and second similar face images similar to the first face images from the image DB, and determining similarities between the input query face image and the face images of the image DB using the similarities between the input query face image and the second similar face images. The step of extracting the first and second similar face images comprises the first similarity determination step of determining similarities between the input query face image and the face images of the image DB, the first similar face image extraction step of extracting the first similar face images in an order of similarities according to results of the first similarity determination step, the second similarity determination step of determining similarities between the first similar face images and the face images of the image DB, and the second similar face image extraction step of extracting the second similar face images for each of the first similar face images in an order of similarities according to results of the second similarity determination step. At this time, the determining of similarities between the input query face image and the face images of the image DB is performed using the following equation

$$Joint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$

where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.

More preferably, the method according to the present invention further comprises the step of outputting the face images of the image DB retrieved based on the determined similarities

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of apparatus for retrieving face images according to an embodiment of the present invention;

FIG. 2 is a flowchart showing a method of retrieving face images according to an embodiment of the present invention;

FIG. 3 is a block diagram showing the face image retrieving method according to the embodiment of the present invention;

FIG. 4 is a flowchart showing a process of determining similarities according to an embodiment of the present invention;

FIGS. 5A and 5B is a view showing a process of dividing a face image according to an embodiment of the present invention; and

FIG. 6 is a table of experimental results obtained by carrying out experiments using a conventional face retrieval method and the face retrieval method of the present invention.

### DESCRIPTION OF THE PREFERRED EMBODIMENTS

Reference now should be made to the drawings, in which the same reference numerals are used throughout the different drawings to designate the same or similar components.

First, the LDA method applied to the present invention is described below. The LDA method is disclosed in the paper of T. K. Kim, et al., “Component-based LDA Face Descriptor for Image Retrieval”, British Machine Vision Conference (BMVC), Cardiff, UK, Sep. 2-5, 2002.

If a training method, such as the LDA method, is employed, the variations of illumination and poses can be eliminated during encoding. In particular, the LDA method can effectively process a face image recognition scenario in which two or more face images are registered, which is an example of identity training.

Meanwhile, the LDA method is the method that can effectively represent between-class disperse (disperse between classes (persons)) having different identities and, therefore, can distinguish the variation of face images caused by the variations of identities from the variations of face images caused by the variations of other factors, such as the variations of illumination and impressions. LDA is a class specific method in that it represents data to be useful to classification. This method can be accomplished by calculating a transformation that that maximizes between-class scatter while minimizing within-class scatter. Accordingly, when a person tries to recognize a face image under an illumination condition different from that at the time of registration, the variation of a face image results from the variations of illumination, it can be determined that the varied face image belongs to the same person. Here is the brief mathematical description of LDA. Given a set of N images {x₁, x₂, . . . , x_{N}} each belonging to one of class C {X₁, X₂, . . . , X_{C}}, LDA selects a linear transformation matrix W so that the ratio of the between-class scatter to the within-class scatter is maximized.

The between-class scatter and the within-class scatter can be represented by the following equation 1.

$$\begin{matrix} {S}_{B} = {\sum }_{i = 1}^{c} {N}_{i} ( {μ}_{i} - μ ) {( {μ}_{i} - μ )}^{T} \\ {S}_{w} = {\sum }_{i = 1}^{c} {\sum }_{x ∈ X} ( {x}_{k} - {μ}_{i} ) {( {x}_{k} - {μ}_{i} )}^{T}\end{matrix} \qquad ( 1 )$$

where μ denotes the mean of entire images, μ₁ denotes the mean image of class Xᵢ, and Nᵢ denotes the number of images in class Xᵢ. If the within-class scatter matrix S_{w} is not singular, LDA finds an orthonormal matrix Wₒₚₜ that maximizes the ratio of the determinant of the between-class scatter matrix to the determinant of the within-class scatter matrix. That is, the LDA projection matrix can be presented by

$${W}_{opt} = arg {max}_{W} \frac{\vert {W}^{T} {S}_{B} W \vert}{\vert {W}^{T} {S}_{W} W \vert} = [ \begin{matrix}{w}_{1} & {w}_{2 } … {w}_{m}\end{matrix} ] \qquad ( 2 )$$

The set of solution {wᵢ|i=1, 2, . . . , m} is that of generalized eigenvectors of S_{B} and S_{W} corresponding to the m largest engenvalues {λᵢ|i=1, 2, . . . , m}.

The LDA face descriptor is described below.

Under the present invention, in order to take advantages of both a desirable linear property and robustness to image variation of the component-based approach, LDA is combined with the component-based representation. The LDA method is applied to divided facial components respectively, by which the precision of retrieval is improved.

For a training data set, an LDA transformation matrix is extracted. Given a set of N training images {x₁, x₂, . . . , x_{N}}, all the images are divided into L facial components by a facial component division algorithm. All patches of each component are gathered and are represented in vector form: the k-^{th} component is denoted as {z₁^{k}, z₂^{k}, . . . , z_{N}^{k}}. Then, for the set of each facial component, a LDA transformation matrix is trained. For the k-^{th} facial component, the corresponding LDA matrix W^{k} is computed. Finally, the set of LDA transformation matrices {W¹, W², . . . , W^{L}} is stored to be used for a training stage or retrieval stage.

For the training face images, L vectors {z¹, z², . . . , z^{L}} corresponding to facial component patches are extracted from a face image x. A set of LDA feature vectors y={y¹, y², . . . , y^{L}} is extracted by transforming the component vectors by the corresponding LDA transformation matrices, respectively. The feature vectors are computed by y^{k}=(W^{k})^{T}z^{k}, k=1, 2, . . . , L.

Consequently, for the component-based LDA method, a face image x is compactly represented by a set of LDA feature vectors, that is, component descriptors {y¹, y², . . . , y^{L}}.

In conclusion, in order to apply the LDA method, LDA transformation matrices W^{k} must be computed for the facial components, and later input query face images are LDA converted by the calculated LDA transformation matrix W^{k} using y^{k}=(W^{k})^{T}z^{k}.

Hereinafter, the Generalized Discriminant Analysis (GDA) method applied to the present invention is described. The GDA method is disclosed in the paper of BAUDAT G., et al., “Generalized Discriminant Analysis Using a Kernel Approach”, Neural Computation, 2000.

GDA is a method designed for non-linear feature extraction. The object of GDA is to find a non-linear transformation that maximizes the ratio between the between-class variance and the total variance of transformed data. In the linear case, maximization of the ratio between the variances is achieved via the eigenvalue decomposition similar to LDA.

The non-linear extension is performed by mapping the data from the original space Y to a new high dimensional feature space Z by a function Φ: Y→Z. The problem of high dimensionality of the new space Z is avoided using a kernel function k: Y×Y→R. The value of the kernel function k(yᵢ,yⱼ) is equal to the dot product of non-linearly mapped vectors Φ(yᵢ) and Φ(yⱼ), i.e., k(yᵢ, yⱼ)=Φ(yᵢ)^{T}Φ(yⱼ), which can be evaluated efficiently without explicit mapping the data into the high dimensional space.

It is assumed that y_{k,i} denotes the i-^{th} training pattern of k-^{th} class, M is the number of classes, Nᵢ is the number of patterns in the i-^{th} class, and

$$N = {\sum }_{k = 1}^{M} {N}_{k}$$

denotes the number of all patterns. If it is assumed that the data are centered, the total scatter matrix of the non-linearly mapped data is

$${S}_{T} = \frac{1}{N} {\sum }_{k = 1}^{M} {\sum }_{i = 1}^{{N}_{k}} Φ ( {y}_{k , i} ) {Φ ( {y}_{k , i} )}^{T} .$$

The between-class scatter matrix of non-linearly mapped data is defined as

$$\begin{matrix} {S}_{B} = \frac{1}{N} {\sum }_{k = 1}^{M} {N}_{k} Φ ( {μ}_{k} ) {Φ ( {μ}_{k} )}^{T} , \\ where Φ ( {μ}_{k} ) = \frac{1}{{N}_{k}} {\sum }_{i = 1}^{{N}_{k}} Φ ( {y}_{k , i} ) . \end{matrix}$$

The aim of the GDA is to find such projection vectors wεZ which maximize the ratio

$$λ = \frac{{w}^{T} {S}_{B} w}{{w}^{T} {S}_{T} w} \qquad ( 3 )$$

It is well known that the vectors wεZ maximizing the ratio, such as Equation 3, can be found as the solution of the generalized eigenvalue problem

λS_{T}w=S_{B}w (4)

where λ is the eigenvalue corresponding to the eigenvector w.

To employ the kernel functions all computations must be carried out in terms of dot products. To this end, the projection vector w is expressed as a linear combination of training patterns, i.e.,

$$w = {\sum }_{k = 1}^{M} {\sum }_{i = 1}^{{N}_{k}} {α}_{k , i} Φ ( {y}_{k , i} ) \qquad ( 5 )$$

where α_{k,i} are some real weights. Using Equation 5, Equation 3 can be expressed as

$$λ = \frac{{α}^{T} KWK α}{α {}^{T} KK α} \qquad ( 6 )$$

where the vector α=(αₖ), k=1, . . . , M and αₖ=(α_{k,i}), i=1, . . . , Nₖ. The kernel matrix K (N×N) is composed from the dot products of non-linearly mapped data, i.e.,

K=(K_{k,l})ₖ₌1, . . . , M, 1=1, . . . . ,M (7)

where K_{k,l}=(k(y_{k,i}y_{l,j}))_{i=1, . . . ,N}_{ₖ}_{,j=1, . . . N}₁.

The matrix W (N×N) is a block diagonal matrix

W=(Wₖ)_{k=l, . . . , M} (8)

where k-^{th} matrix Wₖ on the diagonal has all elements which are equal to

$$\frac{1}{{N}_{k}} .$$

Solving the eigenvalue problem Equation 6 yields the coefficient vectors α that define the projection vectors wεZ. A projection of a testing vector y is computed as

$${w}^{T} Φ ( y ) = {\sum }_{k = 1}^{M} {\sum }_{i = 1}^{{N}_{k}} {α}_{k , i} k ( {y}_{k , i} , y ) \qquad ( 9 )$$

As mentioned above, the training vectors are supposed to be centered in the feature space Z. The centered vector Φ(y)′ is computed as

$${Φ ( y )}^{′} = Φ ( y ) - \frac{1}{N} {\sum }_{k = 1}^{M} {\sum }_{i = 1}^{{N}_{k}} Φ ( {y}_{k , i} ) \qquad ( 10 )$$

which can be done implicitly using the centered kernel matrix K′ (instead of K) since the data appears in terms of dot products only. The centered kernel matrix K′ is computed as

$${K}^{′} = K - \frac{1}{N} IK - \frac{1}{N} KI - \frac{1}{{N}^{2}} IKI where matrix I ( N \times N ) \qquad ( 11 )$$

has all elements equal to 1. Similarly, a testing vector y must be centered by Equation 10 before projecting by Equation 9. Application of Equations 10 and 9 to the testing vector y is equivalent to using the following term for projection

$${w}^{T} {Φ ( y )}^{′} = {\sum }_{k = 1}^{M} {\sum }_{i = 1}^{{N}_{k}} {β}_{k , i} k ( {y}_{k , i} , y ) + b \qquad ( 12 )$$

The centered coefficients β_{k,i} are computed as

$${β}_{k , i} = {α}_{k , i} - \frac{1}{N} J α \qquad ( 13 )$$

and bias b as

$$b = - \frac{1}{N} JKJ α + \frac{1}{{N}^{2}} J α JKJ \qquad ( 14 )$$

where the column vector J (N×1) has all terms equal to 1.

In conclusion, to apply the GDA method, a kernel function to be used should previously be specified, transformation coefficients β and b should be computed, and a query face image input later is transformed through the use of Equation 12 using the computed transformation coefficients β and b.

The present invention proposes to synthesize feature vectors for all facial components (i.e., component descriptors) calculated by LDA transformation (hereinafter referred to as a “first LDA transformation”) into a single vector yᵢ=└yᵢ¹yᵢ² . . . yᵢ^{L}┘ and to extract a related feature vector (i.e., a face descriptor fᵢ) through LDA transformation or GDA transformation (hereinafter referred to as a “second LDA/GDA transformation”). The apparatus and method for retrieving face images using combined component descriptors preconditions training according to the following ‘1. Training Stage’, and ‘2. Retrieval Stage’ is performed when a query face image is input.

1. Training Stage

A. Training face images xᵢ are each divided into L face components according to an image division algorithm and are trained, and first LDA transformation matrices W^{k} (k=1, 2, . . . , L) are calculated for the L facial components.

B. The training face images xᵢ are first LDA transformed using the calculated W^{k} (k=1, 2, . . . , L) and equation y^{k}=(W^{k})^{T}z^{k}, and LDA component descriptors yᵢ¹, yᵢ², . . . , yᵢ^{L} are calculated.

C. With respect to each of the training face images xᵢ, the LDA component descriptors yᵢ¹, yᵢ², . . . , yᵢ^{L} are vectors normalized and synthesized into a single vector yᵢ=└yᵢ¹yᵢ² . . . yᵢ^{L}┘.

The vector normalization is performed using Equation

$${a}^{′} = \frac{a}{‖ a ‖}$$

where α denotes a vector with a length of n.

D. A transformation matrix or transformation coefficient required for the second transformation (LDA or GDA) is calculated by training the single vectors.

When the second LDA transformation is applied, a second LDA transformation matrix W for the single vectors is calculated. When the second GDA transformation is applied, a kernel function is specified and transformation coefficients β and b depending upon the kernel function specified by the training are calculated.

E. With respect to the training face images xᵢ, face descriptors fᵢ to which the first LDA transformation and the second LDA/GDA transformation have been applied are calculated using the calculated transformation matrix or calculated transformation coefficients.

2. Retrieval Stage

A. An input query x is divided into L face components according to an image division algorithm. The L divided face components are first LDA transformed using first LDA transformation matrices W^{k} (k=1, 2, . . . , L) calculated for the L facial components in the training stage.

B. LDA component descriptors yᵢ¹, yᵢ², . . . , yᵢ^{L} with respect to the input query face image x are vectors normalized and synthesized into yᵢ=└yᵢ¹yᵢ² . . . yᵢ^{L}┘.

C. In the case where the second LDA transformation is applied, the single vector is second LDA transformed into a face descriptor f using the second LDA transformation matrix in the training stage. In the case where the second GDA transformation is applied, the single vector is second GDA transformed into a face descriptor f using a specified kernel function and training-specified transformation coefficients β and b.

D. The similarities are determined between the face descriptor f calculated with respect to the input query face image x and the face descriptors fᵢ of the training face images calculated in ‘E’ of the training stage according to a certain similarity determination method.

For reference, the transformation matrices, including the first LDA transformation matrices W^{k} and the second LDA transformation matrices W^{2nd} calculated in the training stage, and the transformation coefficients β and b used for the second GDA transformation should be calculated before the retrieval stage, but the face descriptor fᵢ (hereinafter z=f) may be calculated and stored in the training stage, or may be calculated together with an input query face image when the query face image is input.

An entire procedure of the present invention is described in detail with reference to the accompanying drawings.

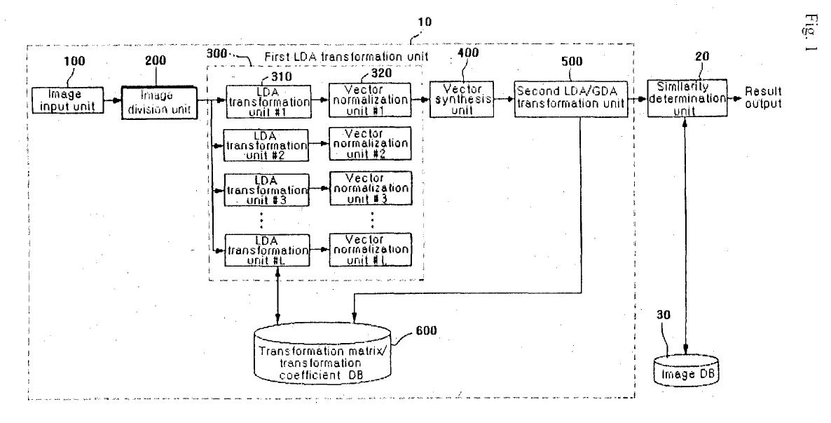

FIG. 1 is a diagram showing the construction of apparatus for retrieving face images according to an embodiment of the present invention.

The face image retrieving apparatus of the embodiment of the present invention may be divided into a cascaded LDA transformation unit 10, a similarity determination unit 30, and an image DB 30 in which training face images are stored. A face descriptor z of an input query face image is calculated through the cascaded LDA transformation unit 10. The similarity determination unit 20 determines the similarities between the calculated face descriptor z of the query face image and face descriptors zᵢ of the training face images stored in the image DB 30 according to a certain similarity determination method, and outputs retrieval results. The output retrieval results are a training face image with the highest similarity, or training face images that have been searched for and are arranged in the order of similarities.

The face descriptors zᵢ are previously calculated in a training stage and stored in the image DB 30, or are calculated by inputting a training face image together with a query face image to the cascaded LDA transformation unit 10 when the query face image is input.

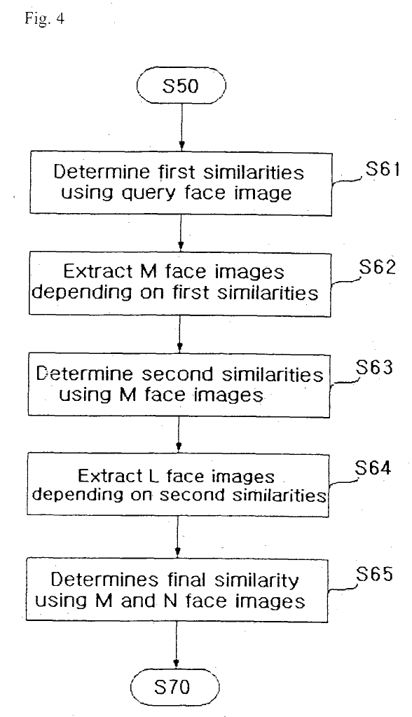

A method of determining similarity according to an embodiment of the present invention will be described later in the detailed description of FIG. 4.

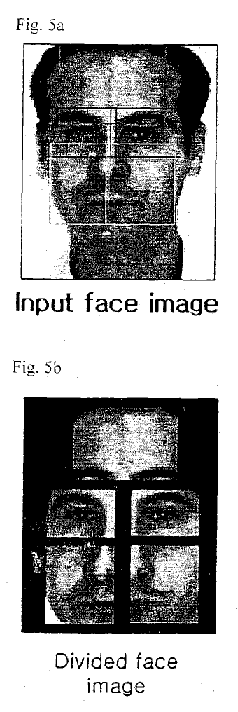

The construction of the cascaded LDA transformation unit 10 is described in detail with reference to FIG. 1. The cascaded LDA transformation unit 10 includes an image input unit 100 for receiving a face image as shown in FIG. 5A, and an image division unit 200 for dividing the face image received through the image input unit 100 into L facial components, such as eyes, a nose and a mouth. An exemplary face image divided by the image division unit 200 is illustrated in FIG. 5B. In FIG. 5B, the face image is divided into five components on the basis of eyes, a nose and a mouth, and the divided five components are partially overlapped with each other. The reason why the divided components are partially overlapped with each other is to prevent the features of a face from being lost by the division of the face image.

L facial components divided by the image division unit 200 are LDA transformed into the component descriptors of the facial components by the first LDA transformation unit 300. The first LDA transformation unit 300 includes L LDA transformation units 310 for LDA transforming L facial components divided by the image division unit 200 into the component descriptors of the facial components, and L vector normalization units 320 for vector normalizing the component descriptors transformed by the LDA transformation units 310. As described above, the vector normalization of component descriptors is performed using the following equation

$${a}^{′} = \frac{a}{‖ a ‖}$$

where α denotes a vector having a length of n.

The L LDA transformation units 310 LDA transform the components of an input query face image using a first LDA transformation matrix W^{k} (k=1, 2, . . . , L) for each of the components stored in a transformation matrix/transformation coefficient DB 600 according to the training results of the training face images within the image DB 30. For example, when the component, including the forehead of FIG. 5B, is 1, that is, k=1, this component including the forehead is LDA transformed using W¹. When the component, including the right eye of FIG. 5B, is 2, that is, k=2, this component, including the forehead, is LDA transformed using W².

For reference, in this embodiment, the L LDA transformation units 310 and the L vector normalization units 320 may be replaced with a single LDA transformation unit 310 and a single vector normalization unit 320 that can process a plurality of facial components in parallel or in sequence, respectively.

L component descriptors vector normalized in the L vector normalization units 320 are synthesized into one vector in a vector synthesis unit 400. The synthesized vector is formed by synthesizing L divided components, so it has L times of the dimensions of single component vector.

A single vector synthesized in the vector synthesis unit 400 is LDA or GDA transformed in the second LDA transformation unit or the second GDA transformation unit 500 (hereinafter referred to as the “second LDA/GDA transformation unit).

The second LDA/GDA transformation unit 500 calculates the face descriptor z by performing second LDA transformation using a second LDA transformation matrix W^{2nd} stored in the transformation matrix/transformation coefficient DB 600 (in the case of the second LDA transformation unit), or by performing second GDA transformation using a previously specified kernel function and training-specified training transformation coefficients β and b stored in the transformation matrix/transformation coefficient DB 600 according to the training results of the training face images within the image DB 30 (in the case of the second GDA transformation unit).

After the face descriptor z of the query face image is calculated in the cascaded LDA transformation unit 10, the similarity determination unit 20 determines the similarities between the face descriptors zᵢ of the training face images stored in the image DB 30 and the calculated face descriptor z of the query face image according to a certain similarity determination method, and outputs retrieval results. The similarity determination method used in the similarity determination unit 20 may be a conventional method of simply calculating similarities by calculating a normalized-correlation between the calculated face descriptor z of the query face image and the face descriptors zi of the training face images stored in the image DB 30, or a joint retrieval method to be described later with reference to FIG. 4. For reference the conventional method of calculating similarities d(z1, z2) by calculating the normalized correlation is performed using the following equation

$$d ( {z}_{1} , {z}_{2} ) = \frac{{z}_{1} \cdot {z}_{2}}{‖ {z}_{1} ‖ ‖ {z}_{2} ‖}$$

For reference, in the face image retrieving apparatus according to the embodiment of the present invention, all the modules of the apparatus may be implemented by hardware, part of the modules may be implemented by software, or all the modules may be implemented by software. Accordingly, it does not depart from the scope and spirit of the invention to implement the apparatus of the present invention using hardware or software. Further, it is apparent from the above description that the apparatus of the present invention is implemented by software and modifications and changes due to the software implementation of the apparatus are possible without departing from the scope and spirit of the invention.

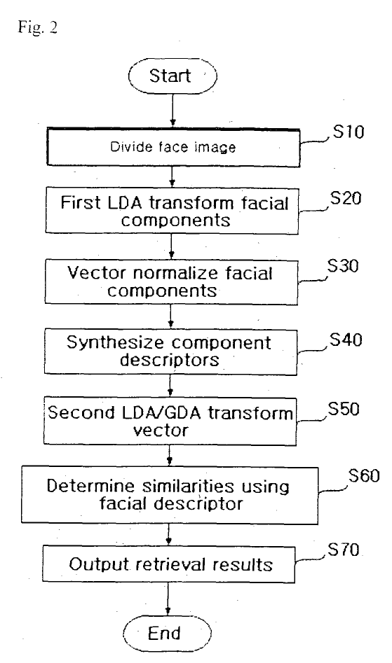

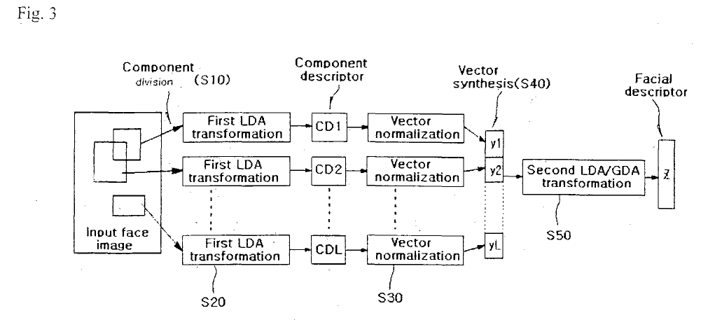

A method of retrieving face images using combined component descriptors according to an embodiment of the present invention is described with reference to FIGS. 2 and 3.

FIG. 2 is a flowchart showing the face image retrieving method according to the embodiment of the present invention. FIG. 3 is a block diagram showing the face image retrieving method according to the embodiment of the present invention.

When a query face image x is input to the image input unit 100, the query face image x is divided into L facial components according to a specified component division algorithm in the image division unit 100 at step S10. In the L LDA transformation unit 310 of the first LDA transformation unit 300, the L components of the input query face image are first LDA transformed using the first LDA transformation matrix W^{k} (k=1, 2, . . . , L) stored in the transformation matrix/transformation coefficient DB 600 according to the training results of the training face images within the image DB 30 at step S20.

The component descriptors CD1, CD2, . . . , CDL are vector normalized LDA transformed in the L LDA transformation unit 310 are vector normalized by the L vector normalization units 320 at step S30, and, thereafter, are synthesized into a single vector having dimensions at step S40.

The single vector into which the component descriptors are synthesized is thereafter second LDA/GDA transformed by the LDA/GDA transformation unit 500 at step S50.

The face descriptor z is calculated by performing the second LDA transformation matrix W^{2nd} calculated in the training stage in the case of the second LDA transformation unit 500, or by performing the second GDA transformation using a specified kernel function and training-specified transformation coefficients β and b in the case of the second GDA transformation unit.

Thereafter, with respect to the input query face image x, the similarity determination unit 20 determines the similarities between the face descriptor z calculated in the second LDA/GDA transformation unit 500 and the face descriptors zi of the training face images stored in the image DB 30 according to a certain similarity determination method at step S60, and outputs retrieval results at step S70. As described above, the output retrieval results are a training face image with the highest similarity or training face images that have been searched for and are arranged in the order of similarities. The face descriptors zᵢ are previously calculated in a training stage and stored in the image DB 30, or are calculated by inputting a training face image together with a query face image to the cascaded LDA transformation unit 10 when the query face image is input.

The similarity determination method according to an embodiment of the present invention is described with reference to FIG. 4.

In the embodiment of the present invention, the joint retrieval method is used as the similarity determination method. The joint retrieval method is the method in which the similarity determination unit 20 extracts the first similar face images from the image DB 30 falling within a certain similarity range on the basis of the input query face image in the order of similarities, extracts the second similar face images from the image DB 30 falling within a certain similarity range on the basis of the first similar face images, and utilizing the first and second similar face images as a kind of weights when determining the similarities between an input query face image and the training face images of the image DB.

Although the above-described embodiment determines similarities by extracting the second similar face images, the present invention can utilize a plurality of similar face images including the third similar face images, the fourth similar face images, etc.

The joint retrieval method according to the present invention is expressed as the following equation 15.

$$Joint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m} \qquad ( 15 )$$

where S_{i,j} denotes the similarity between images i and j, h^{1st} and h^{2nd} denote the indexes of face images highly ranked in first and second similar face images, respectively, and Joint S_{q,m} in the equation 15 denotes the final similarity between a query face image q and a certain training face image m stored in the image DB 30.

For reference, S_{i,j} may be calculated using the conventional cross-correlation and

$${S}_{i , j} = d ( {z}_{i} , {z}_{j} ) = \frac{{z}_{1} \cdot {z}_{2}}{‖ {z}_{i} ‖ ‖ {z}_{j} ‖}$$

In equation 15, S_{q,m} denotes the similarities between a query face image q and the face images m of the image DB 30, S_{q,h}_{^{1st}}ₖ denotes the similarities between the query face image q and the first similar face images, Sₕ_{^{1st}}_{k,m} denotes the similarities between the first similar face images and the face images m of the image DB 30, Sₕ_{^{1st}}_{k,h}_{^{2nd}}ₗ denotes the similarities between the first similar face images and the second similar face images, Sₕ_{^{2nd}}_{l,m} denotes the similarities between the second similar face images and the face images m of the image DB 30, M denotes the number of the first similar face images, and L denotes the number of the second similar face images with respect to each of the second similar face images.

With reference to FIG. 4, the similarity determination method according to an embodiment of the present invention is described below.

After the first similarity determination in which the similarities are determined between a query face image and the training face images of the image DB 30 at step S61, first similar face images are extracted from the image DB 30 in the order of similarities according to the first similarity determination results at step S62.

Thereafter, there is performed second similarity determination in which similarities are determined between the extracted first similar face images and the training face images of the image DB 30 at step S63, second similar face images with respect to each of the first similar face images are extracted from the image DB 30 in the order of similarities according to the second similarity determination results at step S64. A final similarity is determined by calculating the similarities S_{q,m} between the query face image and the training face images of the image DB at step S65.

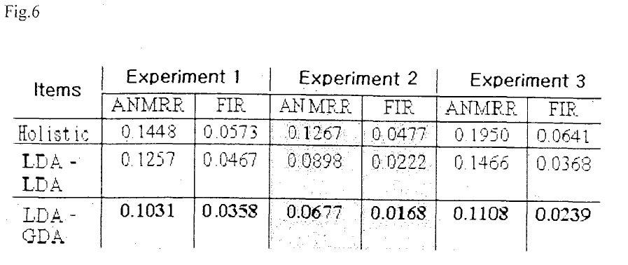

FIG. 6 is a table of experimental results obtained by carrying out experiments using a conventional face retrieval method and the face retrieval method of the present invention. In this table it can be seen that the face retrieval method of the embodiment of the present invention exhibited improved performance compared with the conventional face retrieval method.

In the left column of FIG. 6, ‘Holistic’ denotes the case where LDA transformation is applied to an entire face image without the division of the face image. ‘LDA-LDA’ denotes the face retrieval method according to an embodiment of the present invention in which second LDA transformation is applied after first LDA transformation. ‘LDA-GDA’ denotes the face retrieval method according to another embodiment of the present invention in which second GDA transformation is applied after the first LDA transformation. In ‘LDA-GDA’, a radial basis function was used as a kernel function.

In the uppermost row of FIG. 6, ‘experiment 1’ was carried out in such a way that five face images with respect to each of 160 persons, that is, a total of 800 face images, were trained and five face images with respect to each of 474 persons, that is, a total of 2375 face images, were used as query face images. ‘Experiment 2’ was carried out in such a way that five face images with respect to each of 337 persons, that is, a total of 1685 face images, were trained and five face images with respect to each of 298 persons, that is, a total of 1490 face images, were used as query face images. ‘Experiment 3’ was carried out in such a way that a total of 2285 face images were trained and a total of 2090 face images were used as query face images.

In accordance with the experimental results shown in FIG. 6, the face image retrieval methods according to the embodiments of the present invention have improved Average Normalized Modified Recognition Rates (ANMRRs) and False Identification Rates (FIRs) compared with the conventional face retrieval method.

As described above, the present invention provides an apparatus and method for retrieving face images using combined component descriptors, which generates lower-dimensional face descriptors by synthesizing component descriptors for facial components into a single face descriptor, thus enabling precise face image retrieval while reducing the amount of processed data and retrieval time.

Additionally, in the apparatus and method of the present invention, the joint retrieval method a utilizes an input face image and training face images similar to the input face image as comparison references at the time of face retrieval, thus providing a relatively high face retrieval rate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for retrieving face images using combined component descriptors, comprising:
an image division unit for dividing an input image into facial components;
a Linear Discriminant Analysis (LDA) transformation unit for LDA transforming the divided facial components into component descriptors of the facial components;
a vector synthesis unit for synthesizing the transformed component descriptors into a single vector;
a Generalized Discriminant Analysis (GDA) transformation unit for GDA transforming the single vector into a single face descriptor; and
a similarity determination unit for determining similarities between an input query face image and face images stored in an face image database (DB) by comparing a face descriptor of the input query face image with face descriptors of the face images stored in the face image DB.

2. The apparatus as set forth in claim 1, wherein the LDA transformation unit comprises:
LDA transformation units for LDA transforming the divided facial components into component descriptors of the facial components; and
vector normalization units for vector normalizing the transformed component descriptors into a one-dimensional vector.

3. The apparatus as set forth in claim 2, wherein the LDA transformation units and vector normalization units are each provided for the divided facial components.

4. The apparatus as set forth in claim 1, further comprising a transformation matrix/transformation coefficient DB for storing a transformation matrix or transformation coefficients calculated by training the face images stored in the image DB,
wherein the LDA transformation unit or the GDA transformation unit performs LDA transformation or GDA transformation using the stored transformation matrix or transformation coefficients.

5. The apparatus as set forth in claim 1, wherein:
the image DB stores face descriptors of the face images; and
the comparing of the input query face image with the face images of the image DB is performed by comparing the face descriptor of the input query face image with the face descriptors of the face images stored in the image DB.

6. The apparatus as set forth in claim 1, wherein the divided face components are partially overlapped with each other.

7. The apparatus as set forth in claim 1, wherein the face components into which the input face image is divided comprises eyes, a nose and a mouth.

8. The apparatus as set forth in claim 1, wherein the similarity determination unit extracts first similar face images similar to the input query face image and second similar face images similar to the first face images from the image DB, and determines similarities between the input query face image and the face images of the image DB using the similarities between the input query face image and the second similar face images.

9. The apparatus as set forth in claim 8, wherein the determination of the similarities between the input query face image and the face images of the image DB is performed using the following equation
$$Joint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$
where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.

10. An apparatus for retrieving face images using combined component descriptors, comprising:
an image division unit for dividing an input image into facial components;
a first LDA transformation unit for LDA transforming the divided facial components into component descriptors of the facial components;
a vector synthesis unit for synthesizing the transformed component descriptors into a single vector;
a second LDA transformation unit for LDA transforming the single vector into a single face descriptor; and
a similarity determination unit for determining similarities between an input query face image and face images stored in an face image database (DB) by comparing a face descriptor of the input query face image with face descriptors of the face images stored in the face image DB.

11. The apparatus as set forth in claim 10, wherein the first LDA transformation unit comprises:
LDA transformation units for LDA transforming the divided facial components into component descriptors of the facial components; and
vector normalization units for vector normalizing the transformed component descriptors into a one-dimensional vector.

12. The apparatus as set forth in claim 11, wherein the LDA transformation units and vector normalization units are each provided for the divided facial components.

13. The apparatus as set forth in claim 10, further comprising a transformation matrix/transformation coefficient DB for storing a transformation matrix or transformation coefficients calculated by training the face images stored in the image DB,
wherein the first LDA transformation unit or the second GDA transformation unit performs LDA transformation using the stored transformation matrix or transformation coefficients.

14. The apparatus as set forth in claim 10, wherein:
the image DB stores face descriptors of the face images; and
the comparing of the input query face image with the face images of the image DB is performed by comparing the face descriptor of the input query face image with the face descriptors of the face images stored in the image DB.

15. The apparatus as set forth in claim 10, wherein the divided face components are partially overlapped with each other.

16. The apparatus as set forth in claim 10, wherein the face components into which the input face image is divided comprises eyes, a nose and a mouth.

17. The apparatus as set forth in claim 10, wherein the similarity determination unit extracts first similar face images similar to the input query face image and second similar face images similar to the first face images from the image DB, and determines similarities between the input query face image and the face images of the image DB using the similarities between the input query face image and the second similar face images.

18. The apparatus as set forth in claim 10, wherein the determination of the similarities between the input query face image and the face images of the image DB is performed using the following equation
$$Joint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$
where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.

19. A method of retrieving face images using combined component descriptors, comprising the steps of:
dividing an input image into facial components;
LDA transforming the divided facial components into component descriptors of the facial components;
synthesizing the transformed component descriptors into a single vector;
GDA transforming the single vector into a single face descriptor; and
determining similarities between an input query face image and face images stored in a face image DB by comparing a face descriptor of the input query face image with face descriptors of the face images stored in the face image DB.

20. The method as set forth in claim 19, wherein the step of LDA transforming the divided facial components comprises the steps of:
LDA transforming the divided facial components into component descriptors of the facial components; and
vector normalizing the transformed component descriptors into a one-dimensional vector.

21. The method as set forth in claim 19, wherein the LDA transforming or the GDA transforming is carried out using a transformation matrix or a transformation coefficient calculated by training the face images stored in the image DB.

22. The method as set forth in claim 19, further comprising the step of outputting the face images of the image DB retrieved based on the determined similarities

23. The method as set forth in claim 19, wherein the comparing of the input query face image with the face images of the image DB is performed by comparing the face descriptor of the input query face image with the face descriptors of the face images stored in the image DB.

24. The method as set forth in claim 19, wherein the divided face components are partially overlapped with each other.

25. The method as set forth in claim 19, wherein the face components into which the input face image is divided comprises eyes, a nose and a mouth.

26. The method as set forth in claim 19, wherein the step of determining similarities comprises the steps of:
extracting first similar face images similar to the input query face image and second similar face images similar to the first face images from the image DB; and
determining similarities between the input query face image and the face images of the image DB using the similarities between the input query face image and the second similar face images.

27. The method as set forth in claim 26, wherein the step of extracting the first and second similar face images comprises:
the first similarity determination step of determining similarities between the input query face image and the face images of the image DB;
the first similar face image extraction step of extracting the first similar face images in an order of similarities according to results of the first similarity determination step;
the second similarity determination step of determining similarities between the first similar face images and the face images of the image DB; and
the second similar face image extraction step of extracting the second similar face images for each of the first similar face images in an order of similarities according to results of the second similarity determination step.

28. The method as set forth in claim 27, wherein the determining of similarities between the input query face image and the face images of the image DB is performed is using the following equation
$$J oint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$
where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.

29. A method of retrieving face images using combined component descriptors, comprising the steps of:
dividing an input image into facial components;
LDA transforming the divided facial components into component descriptors of the facial components;
synthesizing the transformed component descriptors into a single vector;
LDA transforming the single vector into a single face descriptor; and
determining similarities between an input query face image and face images stored in a face image DB by comparing a face descriptor of the input query face image with face descriptors of the face images stored in the face image DB.

30. The method as set forth in claim 29, wherein the step of LDA transforming the divided facial components comprises the steps of:
LDA transforming the divided facial components into component descriptors of the facial components; and
vector normalizing the transformed component descriptors into a one-dimensional vector.

31. The method as set forth in claim 29, wherein the LDA transforming is carried out using a transformation matrix or a transformation coefficient calculated by training the face images stored in the image DB.

32. The method as set forth in claim 29, further comprising the step of outputting the face images of the image DB retrieved based on the determined similarities

33. The method as set forth in claim 29, wherein the comparing of the input query face image with the face images of the image DB is performed by comparing the face descriptor of the input query face image with the face descriptors of the face images stored in the image DB.

34. The method as set forth in claim 29, wherein the divided face components are partially overlapped with each other.

35. The method as set forth in claim 29, wherein the face components into which the input face image is divided comprises eyes, a nose and a mouth.

36. The method as set forth in claim 29, wherein the step of determining similarities comprises the steps of:
extracting first similar face images similar to the input query face image and second similar face images similar to the first face images from the image DB; and
determining similarities between the input query face image and the face images of the image DB using the similarities between the input query face image and the second similar face images.

37. The method as set forth in claim 36, wherein the step of extracting the first and second similar face images comprises:
the first similarity determination step of determining similarities between the input query face image and the face images of the image DB;
the first similar face image extraction step of extracting the first similar face images in an order of similarities according to results of the first similarity determination step;
the second similarity determination step of determining similarities between the first similar face images and the face images of the image DB; and
the second similar face image extraction step of extracting the second similar face images for each of the first similar face images in an order of similarities according to results of the second similarity determination step.

38. The method as set forth in claim 37, wherein the determining of similarities between the input query face image and the face images of the image DB is performed using the following equation
$$J oint {S}_{q , m} = {S}_{q , m} + {\sum }_{k = 1}^{M} {S}_{q , {h}^{1 st} k} \cdot {S}_{{h}^{1 st} k , m} + {\sum }_{k = 1}^{M} {S}_{q , {h}^{1 st} k} {\sum }_{l = 1}^{L} {S}_{{h}^{1 st} k , {h}^{2 nd} l} \cdot {S}_{{h}^{2 nd} l , m}$$
where S_{q,m} denotes similarities between the input query face image q and the face images m of the image DB, S_{q,h}_{^{1st}}ₖ denotes similarities between the query face image q and the first similar face images, Sₕ_{^{1st}}_{k,m} denotes similarities between the first similar face images and the face images m of the image DB, Sₕ_{^{1st}}_{k,h}_{^{2nd}}ₗ denotes similarities between the first similar face images and the second similar face images, Sₕ_{^{2nd}}_{l,m} denotes similarities between the second similar face images and the face images m of the image DB, M denotes a number of the first similar face images, and L denotes a number of the second similar face images with respect to each of the second similar face images.
